(19) United States
(12) Patent Application Publication
(10) Pub. No.: US 2008/0056917 A1
(43) Pub. Date: Mar. 6, 2008

(54) Fuel Feed Unit

(75) Inventors: Gunter Wagner, Wolfhagen (DE); Juergen Zoell, Heringen (DE)

Correspondence Address: HANLEY, FLIGHT & ZIMMERMAN, LLC, 150 S. WACKER DRIVE, SUITE 2100, CHICAGO, IL, 60606, US

(73) Assignee: Siemens Aktiengesellschaft

(21) Appl. No.: 10/585,905

(22) PCT Filed: Dec. 17, 2004
(86) PCT No.: PCT/EP04/53582

§ 371 Date: Jul. 12, 2006

(30) Foreign Application Priority Data
Jan. 16, 2004 (DE) 10 2004 002 458.8

(51) Int. Cl. F02M 37/08

(52) U.S. Cl. 417/410.1

(57) ABSTRACT

Disclosed is a fuel conveying unit comprising an electric motor and a return ring (8) that is made of plastic-bonded ferrite as a single piece along with magnetic shells (10). The magnetic shells (10) induce a magnetic flux that is closed by the return ring (8). The electric motor requires a particularly low number of parts that are to be assembled and can be produced inexpensively.

### BACKGROUND OF THE INVENTION

The invention relates to a fuel feed unit for delivering fuel, having an electric motor, an electric motor stator ring, magnet shells arranged inside the stator ring and a motor casing to accommodate the stator ring.

Such fuel feed units with the electric motor for driving a fuel pump are commonly used in modern motor vehicles and are known in practice. The stator of the electric motor has a subassembly comprising a stator ring with two magnet shells and two magnet retaining springs. The function of this subassembly is to provide a magnetic field, the magnet shells inducing the magnetic flux and the magnetic field being closed by the stator ring. The magnet retaining springs serve for fixing the magnet shells to the stator ring. This subassembly is connected to the motor casing and to an end plate for supporting the rotor of the electric motor.

A disadvantage with the electric motor of the known fuel feed unit is that it comprises a large number of components and is costly to assemble.

The object of the invention is to design a fuel feed unit of the aforementioned type so that it is as inexpensive to manufacture as possible.

### BRIEF DESCRIPTION OF THE INVENTION

According to the invention this object is achieved in that a one-piece body comprises the stator ring and an adjoining component of the motor casing and/or of the magnet shells.

This design means that the stator ring arranged between the motor casing and the magnet shells is at least produced in one piece with a further adjoining component. This serves to minimize the number of components of the electric motor that have to be assembled. Producing the stator ring in one piece with the magnet shells furthermore means that the number of components is minimized, since no magnet retaining springs are needed for pretensioning the magnet shells. Producing the electric motor in one piece with the motor casing has the advantage that it avoids close tolerances when introducing the two components radially one inside the other. The fuel feed unit according to the invention is therefore particularly inexpensive to manufacture.

According to an advantageous development of the invention the one-piece body is particularly inexpensive to produce by the injection molding method if it is produced from plastics with ferrite bonded therein.

According to another advantageous development of the invention the production costs of the electric motor are further reduced if the plastic is polyphenyl sulfide.

The ready-assembled electric motor is generally inserted into a tubular housing part of the fuel feed unit and connected thereto. In order to facilitate fitting of the electric motor in the fuel feed unit according to the invention, a casing part of a feed pump for delivering fuel in a fuel tank is produced in one piece with the body.

In order to further facilitate the assembly of the fuel feed unit according to the invention, the body comprising the stator ring has a flange for joining to a connection piece intended for the connection of a fuel line.

The one-piece body comprising the stator ring and the motor casing might comprise a flange for connection to an end plate for supporting a rotor of the electric motor, for example, as in the known fuel feed unit. In order to further reduce the number of components of the electric motor, according to another advantageous development of the invention the body comprising the stator ring has a bearing for the rotor.

In order to further reduce the number of components of the fuel feed unit according to the invention, the body comprising the stator ring is joined in one piece to a component having one or more ducts of the feed pump.

### BRIEF DESCRIPTION OF THE DRAWINGS

The invention permits numerous embodiments. In order to further illustrate the basic principle of the invention several embodiments are represented in the drawing and are described below. In the drawing:

FIG. 1 shows, in schematic form, a sectional representation through functional components of the feed unit according to the invention with an electric motor,

FIG. 2 shows a one-piece body comprising a stator ring and magnet shells of the electric motor in FIG. 1,

FIG. 3 shows a one-piece body comprising a stator ring and a motor casing of the electric motor in FIG. 1,

FIG. 4 shows a one-piece body comprising a stator ring and an end plate of the feed unit according to the invention,

FIG. 5 shows a one-piece body comprising a stator ring and a casing part of a feed pump driven by the electric motor in FIG. 1,

FIG. 6 shows a one-piece body comprising a stator ring and a motor casing of the electric motor in FIG. 1.

### DETAILED DESCRIPTION OF THE INVENTION

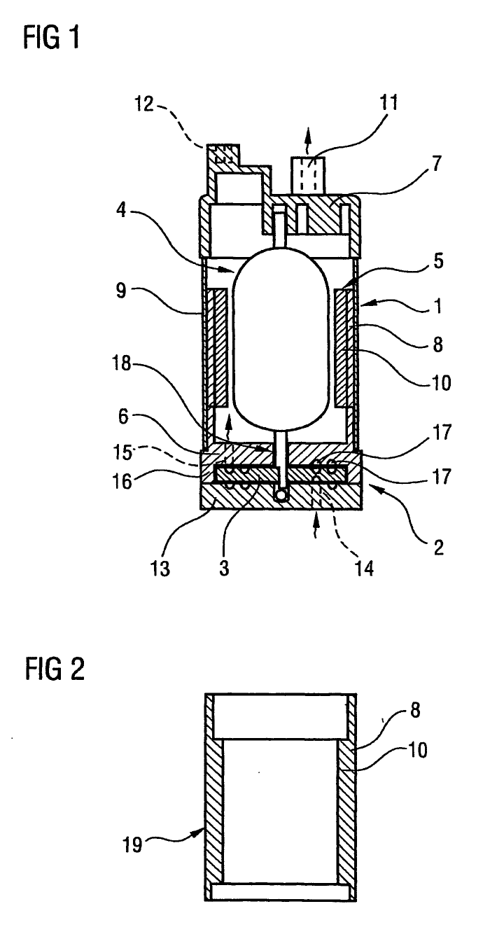

FIG. 1 shows a feed unit according to the invention for delivering fuel in a motor vehicle. The feed unit has a feed pump 2 driven by an electric motor 1 and having a driven impeller 3. The electric motor I has a rotor 4 and a stator 5. The rotor 4 is rotatably supported in a pump casing 6 and in a connecting piece 7 and is connected to the impeller 3. The electric motor 1 has a motor casing 9 enclosing a stator ring 8. Generally two magnet shells 10 are arranged on the inside of the stator ring 8. These magnet shells 10 induce a magnetic flux in the rotor 4. The stator ring 8 closes the magnetic flux of the magnet shells 10. The connecting piece 7 has a connection 11 for a fuel line (not shown). Terminal contacts 12 for the electric motor 1 are furthermore arranged on the connection piece 7. The feed pump 2 delivers fuel from an inlet duct 14 arranged in a casing part 13 via an outlet duct 15 arranged in the end plate 6, through the electric motor 1 to the connection piece 7. The end plate 6 and the casing part 13 are secured to one another at a distance by means of a spacer 16. The spacer 16 is slightly greater in height than the impeller 3. The fuel flows are clearly marked by arrows. Segmental ducts 17 of the feed pump 2, in the form of a side channel pump, and a bearing 18 for the rotor 4 are arranged in the end plate 6. The representation of the components in FIG. 1 is only intended to illustrate their function in the feed unit.

FIG. 2 shows a one-piece body 19 comprising a stator ring 8 and magnet shells 10 of the feed unit in FIG. 1. The one-piece body 19 is composed of plastic with embedded ferrite particles and is produced by the injection molding method in an injection mold from which it can be removed axially. This one-piece body is inserted into the feed unit in FIG. 1 and is connected to the motor casing 9 of the electric motor 1.

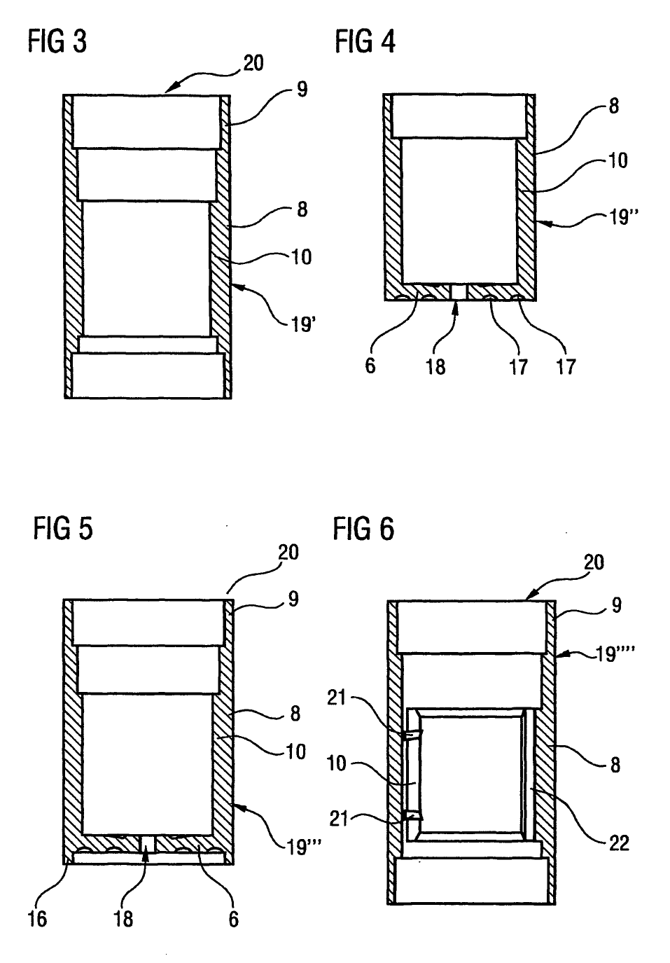

FIG. 3 shows a one-piece body 19′ comprising a stator ring 8, magnet shells 10 and motor casing 9 of the electric motor 1. This one-piece body 19′ is made from plastics containing ferrite as described in FIG. 2 and can be inserted into the feed unit in FIG. 1 and connected to the connecting piece 7 and the feed pump 2. The one-piece body 19′ furthermore has a flange 20 for connection to the connecting piece 7 in FIG. 1.

FIG. 4 shows a one-piece body 19″, which differs from that in FIG. 2 mainly in that the pump casing 6 in FIG. 1 is produced in one piece with the stator ring 8 and the magnet shells 10. The segmental ducts 17 of the feed pump 2 and one of the bearings 18 for the rotor 4 are arranged in the pump casing 6.

FIG. 5 shows a one-piece body 19″′, in which the stator ring 8, magnet shells 10, motor casing 9 and pump casing 6 are produced in one piece with the spacer 16 of the feed pump 2.

FIG. 6 shows a component for the feed unit in FIG. 1, in which the magnet shells 10 are fixed to the inside of a one-piece body 19″″ comprising a stator ring 8 and a motor housing 9, by means of a magnet retaining spring 21. For alignment of the magnet shells 10, the one-piece body 19″″ has a locking cam 22 corresponding to the magnet retaining spring 21.

1. A fuel feed unit for delivering fuel, having an electric motor, an electric motor stator ring, magnet shells arranged inside the stator ring and a motor casing to accommodate the stator ring, characterized in that a one-piece body (19, 19′, 19″, 19″′, 19″″) comprises the stator ring (8) and an adjoining component of the motor casing (9) and/or of the magnet shells (10).

2. The fuel feed unit as claimed in claim 1, characterized in that the one-piece body (19, 19′, 19″, 19″′, 19″″) is produced from plastics with ferrite bonded therein.

3. The fuel feed unit as claimed in claim 2 characterized in that the plastic is polyphenyl sulfide.

4. The fuel feed unit as claimed in claim 1, characterized in that a casing part of a feed pump (2) for delivering fuel in a fuel tank is produced in one piece with the body (19″, 19″′).

5. The fuel feed unit as claimed in claim 1, characterized in that the body (19′, 19″′, 19″″) comprising the stator ring (8) has a flange (20) for joining to a connection piece (7) intended for the connection of a fuel line.

6. The fuel feed unit as claimed in claim 1, characterized in that the body (19″, 19″′) comprising the stator ring (8) has a bearing (18) for the rotor (4).

7. The fuel feed unit as claimed in claim 1, characterized in that the body (19″, 19″′) comprising the stator ring (8) is joined in one piece to a component having a duct (17) of the feed pump (2).
